(19) United States
(12) Patent Application Publication
(10) Pub. No.: US 2013/0304695 A1
(43) Pub. Date: Nov. 14, 2013

(54) METHOD FOR PROVIDING DATABASE MANAGEMENT AND THE DATABASE MANAGEMENT SERVER THEREOF

(71) Applicants: Joon Ik Lee, Seoul (KR); Chin Sik Lee, Seoul (KR); Jung In Park, Seoul (KR); Hye Kyoung Chon, Seoul (KR); Deok Young Hwang, Seoul (KR); Jeong Hyun Wi, Seoul (KR)

(72) Inventors: Joon Ik Lee, Seoul (KR); Chin Sik Lee, Seoul (KR); Jung In Park, Seoul (KR); Hye Kyoung Chon, Seoul (KR); Deok Young Hwang, Seoul (KR); Jeong Hyun Wi, Seoul (KR)

(73) Assignee: LG CNS CO., LTD., Seoul (KR)

(21) Appl. No.: 13/831,253

(22) Filed: Mar. 14, 2013

(30) Foreign Application Priority Data
Mar. 22, 2012 (KR) KR10-2012-0029530

(51) Int. Cl. G06F 17/30

(52) U.S. Cl. CPC G06F 17/30289
USPC 707/609

(57) ABSTRACT

The present invention provides diagnosis and management of a database system. The method for database management comprises (a) generating a list of at least one database managed by the database system; (b) providing a list of diagnostic items including a plurality of diagnostic items which can be carried out against at least one database selected from the list; and (c) carrying out diagnosis by providing the database system with at least one script related to at least one diagnostic item selected from the list of diagnostic items, wherein the at least one script is configured to have a run time set up differently according to the status of the database system. Database management provides various diagnostic items through remote connection to a particular database system and providing a quantitative analysis of the corresponding diagnosis result, thereby enabling more complete and comfortable database management.

### CROSS-REFERENCE TO RELATED APPLICATION

This application claims priority under 35 U.S.C. §119 to Korean Patent Application No. 10-2012-0029530, filed on Mar. 22, 2012, in the Korean Intellectual Property Office, the contents of which is incorporated herein by reference.

### BACKGROUND OF THE INVENTION

1. Field of the Invention

The present invention relates to a database management technology and more specifically, a method for database management capable of evaluating a database system by using various evaluation factors for a remotely connected database system and a database management server for the method.

2. Discussion of the Related Art

Rapid progress of computing environment accordingly forces development of database systems satisfying higher capacity and diversity. Along with the development, there are needs for a technology capable of managing a database system at a remote place physically separated from the database system.

Therefore, there are various kinds of demand for a database management technology which can be used for carrying out diagnosis or evaluation of a database system through remote connection to the corresponding database system.

However, conventional database management technologies were designed to provide only the data related to particular performance such as dataflow, available capacity, or the number of processors running but incapable of providing a quantitative measure with which current system status can be figured out exactly.

Moreover, the conventional database management technologies are unable to prevent an additional load from being applied to a database system, which is generated when diagnosis or evaluation is carried out for the corresponding database system. That is to say, in case a predetermined process is operated for the purpose of diagnosis or evaluation of a database system, the conventional database management technologies are unable to carry out a function of checking the status of the database system in question or controlling operation of the corresponding process according to the status checked.

### SUMMARY OF THE INVENTION

The present invention has been made in an effort to provide a method for database management capable of providing various diagnostic items through remote connection to a particular database system and providing a quantitative analysis of the corresponding diagnosis result, thereby enabling more complete and comfortable database management; and a database management server for the method.

The present invention provides a method for database management which connects to a predetermined database system through a network and is carried out in a database management server capable of providing diagnosis of the database system connected, the method comprising: generating a list of at least one database managed by the database system; providing a list of diagnostic items including a plurality of diagnostic items which can be carried out against at least one database selected from the list; and carrying out diagnosis by providing the database system with at least one script related to the at least one diagnostic item selected from the list of diagnostic items, wherein the at least one script is configured to have a run time set up differently according to the status of the database system.

In another embodiment, the present invention provides a method for database management which is carried out in a database management server capable of connecting to a predetermined database system through a network and analyzing the connected database system, the method comprising: providing a list of diagnostic items including a plurality of diagnostic items carried out in the database system; generating at least one script for carrying out the diagnosis and associating the script with the diagnostic item; and modifying the at least one script associated with the at least one diagnostic item selected from the list of diagnostic items to reflect the status of the database system and carry out diagnosis by executing the modified at least one script.

In another embodiment, the present invention provides a database management server which connects to a predetermined database system through a network and provides diagnosis of the database system, the database management server comprising: an evaluation item management unit managing a plurality of diagnostic items carried out in the database system; a script management unit managing a plurality of scripts for carrying out a predetermined diagnosis in relation to each of the plurality of diagnostic items; a controller selecting at least one script associated with at least one diagnostic item selected from the plurality of diagnostic items and providing the database system with the selected at least one script by setting up limiting conditions on the execution thereof.

In another embodiment of the invention, the present invention provides A computer-readable storage medium storing computer instructions, which when executed, enables a computer system to carry out a method for database management and provide diagnosis of a connected database system, the computer instructions comprising: generating a list of at least one database managed by the database system; providing a list of diagnostic items including a plurality of diagnostic items which can be carried out for at least one database selected from the list; and carrying out a diagnosis against the database system by providing the database system with at least one script related to at least one diagnostic item selected from the list of diagnostic items, wherein the at least one script is configured to have a run time set up differently according to the status of the database system.

In another embodiment, the invention provides a method for deploying a database management server for use in a computer system that provides data integration using automated data processing based on target metadata, the method comprising: providing a computer infrastructure operable to: provide a list of diagnostic items including a plurality of diagnostic items, which can be carried out in the database system; generate at least one script for carrying out the diagnosis and relating the generated at least one script to the diagnostic item; and modify at least one script associated with the at least one diagnostic item selected from the list of diagnostic items by reflecting the status of the database system and carrying out diagnosis by executing the modified at least one script.

### BRIEF DESCRIPTION OF THE DRAWINGS

The accompanying drawings, which are included to provide a further understanding of this document and constitute a part of this specification, illustrate embodiments of this document and together with the description serve to explain the principles of this document.

FIG. 1 illustrates a database management server and a database system according to the present invention;

FIG. 2 is a block diagram of one embodiment of a database management server according to the present invention;

FIG. 3 is a flow diagram illustrating one embodiment of a method for database management according to the present invention;

FIG. 4 is a flow diagram illustrating another embodiment of a method for database management according to the present invention;

FIGS. 5 to 12 illustrate one example of a script according to the present invention; and

FIGS. 13 to 18 are examples of various types of report which can be provided to the user according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

This disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments. Meanwhile, terms introduced in this document should be understood as follows.

Terms such as first, second, and so on are intended for identifying one component from another but the technical scope should not be limited by the terms. For example, a first component may be called a second component and vice versa.

If a component is said to be “connected” to a different component, the component may be directly connected to the different component but a third component may exist to connect the two components even though the two components may be connected directly. On the other hand, if a component is said to be “connected directly” to another component, it should be interpreted that there is no further component between the two components. Similarly, other expressions describing relationships between components such as “between” and “just between” or “next to” and “immediately next to” and the like should also be understood in the same way as above.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “computing,” “determining,” “evaluating,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

Singular expression should be interpreted to include plural expressions unless otherwise stated explicitly. Terms such as “include” or “have” are meant to signify existence of embodied characteristics, numbers, steps, behavior, components, modules, and combinations thereof, which should be understood that possibility of existence or addition of one or more characteristics, numbers, steps, behavior, components, modules, and combinations thereof are not precluded beforehand.

Identifying symbols for individual steps (for example, a, b, c, and so on) are used for the purpose of convenience of description and do not intend to represent the order of the steps; unless a particular order is specified, individual steps can be carried out in an order different from that used in this document. In other words, individual steps can be carried out in the same order as described in the document, virtually at the same time, or in the opposite order.

The present invention can be implemented in a computer-readable storage medium in the form of computer-readable program codes. Computer-readable recording media include all types of recording apparatus in which computer-readable data are stored. Examples of a computer-readable storage medium are ROM, RAM, CD-ROM, magnetic tape, floppy tape, optical data storage device, and so on. Implementation in the form of carrier waves (for example, transmission through the Internet) can also be regarded as an example of computer-readable storage medium. Computer-readable recording media can be distributed across computer systems connected to each other through a network and computer-readable program codes can be stored and executed in a distributed manner.

Unless otherwise defined, all the terms used in this document possess the same meaning as understood by those skilled in the art to which the present invention belongs. The terms such as those defined in a dictionary for general use should be interpreted to carry the same contextual meaning in the related technology and they should not be interpreted to possess an ideal or excessively formal meaning.

FIG. 1 illustrates a database management server and a database system according to the present invention.

The database system 100 represents a database system subject to evaluation.

The database system 100 can set up a predetermined access right and path for the database management server 200. For example, it can provide the right of query or access to a particular port.

The database system 100 includes a database, database management system (DBMS), and so on; and manages multiple databases depending on embodiments.

The database management server 200, being connected to the database system 100 through a network, carries out diagnosis of one or more databases of the corresponding database system 100.

In one embodiment, the database management server 200 provides a report generated after being given the right of access to predetermined user terminals, or carries out evaluation of the database system 100 based on the control through a user terminal.

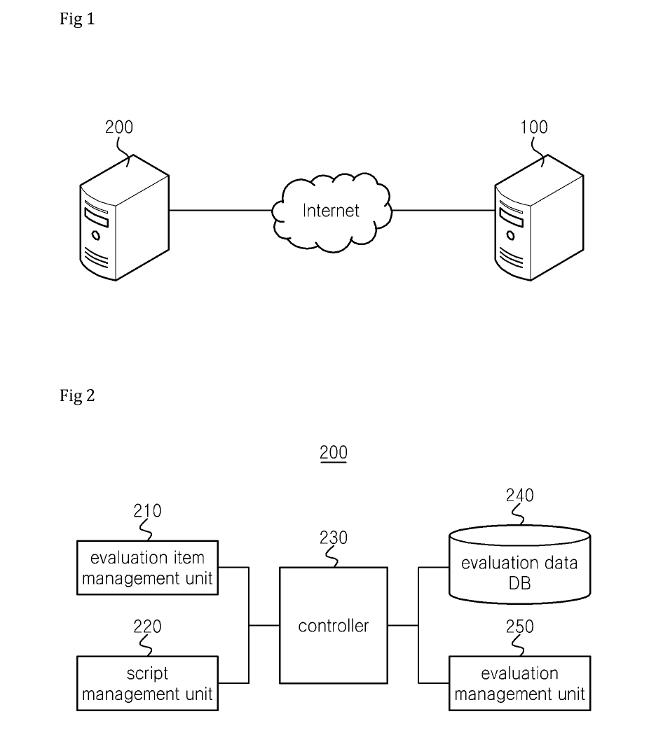

The database management server 200 will be described in more detail with reference to FIG. 2.

FIG. 2 is a block diagram of one embodiment of database management server 200 according to the present invention.

As shown in greater detail, the database management server 200 comprises an evaluation item management unit 210, a script management unit 220, and a controller 230. In one embodiment, the database management server 200 further comprises an evaluation data DB 240 or a report management unit 250.

The evaluation item management unit 210 manages a plurality of diagnostic items which can be carried out against the database system 100. In one embodiment, the evaluation item management unit 210 manages diagnostic items in the form of a hierarchical structure and provides a list of the diagnostic items. In another embodiment, the evaluation item management unit 210 identifies diagnostic items applicable to a particular database and generates a list of diagnostic items for the corresponding database by using the applicable diagnostic items. That is, the evaluation item management unit 210 generates a list by checking a database managed by database system 100 and provides a list of diagnostic items, including diagnostic items applicable to each database of database system 100.

In one embodiment, the evaluation item management unit 210 determines a diagnostic item based on a past diagnosis history. For example, the evaluation item management unit 210 checks a past diagnosis history of the database system 100 and, by using the diagnosis history checked, provides a list of diagnostic items (not shown) including a recommendation for at least one diagnostic item. In one non-limiting embodiment, a diagnostic item includes at least one of: basic information about the database system, configuration management, failure management, capacity management, performance management, availability management, and security management. Furthermore, the at least one diagnostic item is associated with at least one script for the corresponding diagnosis.

As also shown in FIG. 2, the database management server 200 comprises the script management unit 220, which manages a plurality of scripts intended for carrying out a predetermined diagnosis, the plurality of scripts being associated with each of multiple diagnostic items.

In one embodiment, a run time can be set up individually for each script and during the run time set up, the script is executed in the database system 100. As a result, this generates diagnostic data about the corresponding database(s) of database system 100. For example, a script contains a predetermined query with which system information about the database system 100 can be obtained. If a load applied to the database system 100 in response to the query exceeds a predetermined load, execution of the corresponding script is stopped.

In one embodiment, the script management unit 220 carries out diagnosis by providing a standardized script. For example, the script management unit 220 generates a plurality of standardized diagnostic scripts based on a database management system (DBMS) or version information thereof, and classifies the plurality of diagnostic scripts generated according to the diagnostic items, thereby allowing the evaluation item management unit 210 to generate a list of diagnostic items for the database system 100.

As also shown in FIG. 2, the database management server 200 comprises the controller 230, which provides management of the database system 100 by controlling other components of the database management server 200. The controller 230, by imposing a predetermined constraint (e.g., execution limiting conditions) on a script, can provide management of the database system 100 while ensuring reliable performance of the database system 100. For example, the controller 230 selects at least one script associated with at least one diagnostic item selected from a plurality of diagnostic items and provides the database system 100 with the selected at least one script by setting up execution limiting conditions thereon. Here, the execution limiting conditions may correspond to a maximum run time. In other words, by limiting a query execution time of the script, system overload can be avoided.

In one embodiment, the controller 230 checks a current status of the database system 100 and configures a run time (i.e., a maximum time) of at least one script by reflecting the current status checked. For example, the controller 230 provides at least one script in which a run time is specified and, if the database system's 100 load exceeds a predetermined value while the provided at least one script is running, controls the provided at least one script to stop running.

In another embodiment, the controller 230 checks system information of the database system 100 while the modified at least one script is running in the database system 100 and, if a load exceeding a predetermined value is applied to the database system 100, controls the at least one script in execution to stop running.

Furthermore, the controller 230 is configured to assign priorities separately to the scripts, thereby allowing a high quality evaluation while ensuring operational reliability of the database system 100 by reflecting the priorities in addition to the execution time limitation. For example, the controller 230, reflecting the status of the database system 100, sets up a maximum execution time for at least one script, and assign priorities with different rank to the at least one script. As a result, the priority order is configured to be considered first over the maximum execution time.

In one embodiment, a script (e.g., an item) with a priority is carried out in the database system 100 prior to other ordinary scripts. For example, a query which is carried out by a script with a high priority is prioritized over ordinary queries processed in the database system 100 and is therefore processed first.

In one embodiment, the controller 230 can execute a script with a predetermined priority even if the load generated in the database system 100 exceeds a predetermined load. For example, a script capable of carrying out diagnosis of a current load of the database system 100 can be made to operate even in the case of overload of the database system 100. This is intended to figure out a problematic situation of a database system 100 by carrying out a diagnosis of the corresponding database system 100 beforehand.

As also shown in FIG. 2, the database management server 200 comprises the evaluation data DB 240, which stores data from an evaluation carried out against database system 100.

As also shown in FIG. 2, the database management server 200 comprises the report management unit 250, which processes raw data generated as a result of carrying out at least one script according to a predetermined quantitative criterion. The report management unit further evaluates the database system 100 by comparing the processed data with predetermined reference data. The report management unit 250 generates a report by using the evaluation result of the comparison

In one embodiment, the report management unit 250 receives raw data generated as a result of carrying out a script from the database system 100, and processes data according to a predetermined quantitative criterion against the database system 100.

In another embodiment, the report management unit 250 generates a temporary table which can store the raw data and stores in the temporary table at least one of: data obtained from execution of the script and extended data obtained from application of an extended procedure for the data. The report management unit 250 determines the raw data by separating or merging at least part of the data stored in the temporary table based on information in the operating system for the database system.

The report management unit 250 then obtains an evaluation result in terms of evaluation items by using the data processed according to the predetermined quantitative criterion. For example, the report management unit 250 evaluates the database system 100 by comparing the processed data with reference data assigned to the database system 100 for each of the evaluation items, and then converts the comparison result into a grade data.

In one embodiment, the report management unit 250 generates evaluation data by using reference data. For example, the report management unit 250 compares an execution result of at least one script with the reference data of the corresponding database system, and provides evaluation data obtained from the comparison.

In one embodiment, the report management unit 250 generates a diagnostic report including at least one evaluation result. An exemplary diagnostic report will be described in more detail below with reference to FIGS. 13 to 18.

In one embodiment, the report management unit 250 provides a comparison result of diagnostic reports. For example, the report management unit 250 checks a history of past diagnostic reports stored in the database system 100, and provides a result of comparing the past history of diagnostic reports with a current diagnostic report.

In one embodiment, the report management unit 250 configures a template for predetermined diagnostic items and makes use thereof. For example, a template for diagnostic items is configured and stored, and diagnostic items are formed based on the stored template. In another example, a template designed for a particular item can be made to be reused to substitute for another item.

In one embodiment, the report management unit 250 restructures a generated diagnostic report into a document with a predetermined form. For example, the report management unit 250 restructures a predetermined diagnostic report into a document of EXCEL type and provides the diagnostic report to a user terminal for later use.

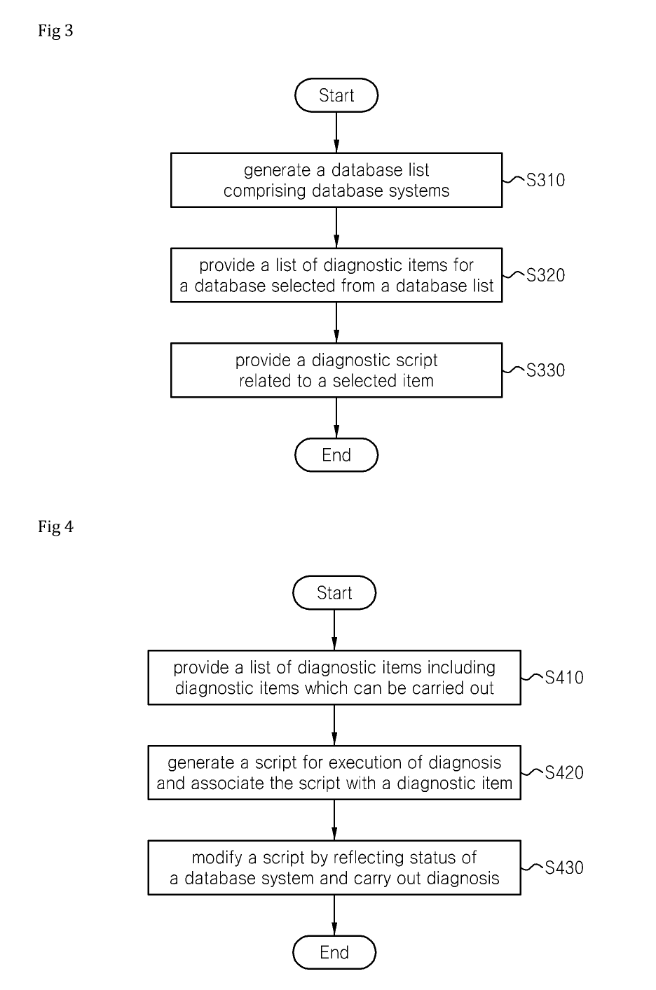

In what follows below, various embodiments of a non-limiting approach for database management will be described with reference to FIGS. 3 and 4. Since the embodiments to be described below are carried out in the database management server 200, overlapping parts will not be repeatedly described for the sake of brevity. However, those skilled in the art would be able to more clearly understand the embodiments of a method for database management below.

FIG. 3 is a flow diagram illustrating one embodiment of a method for database management according to the present invention.

To illustrate one embodiment of a method for database management with reference to FIG. 3, as shown, the database management server 200 generates a list of at least one database managed by a database system at S310.

The database management server 200 provides a list of diagnostic items including a plurality of diagnostic items which can be carried out in at least one database selected from the database list at S320, and carries out a diagnosis by providing the database system 100 with at least one script associated with at least one diagnostic item selected from the list of diagnostic items at S330. Accordingly, the at least one script can have a run time configured differently according to the status of the database system 100.

In one embodiment of the step S320, the database management server 200 generates a plurality of standardized diagnostic scripts based on a database management system (DBMS) or version information thereof, and then generates the list of diagnostic items by classifying the plurality of diagnostic scripts according to the diagnostic items.

In another embodiment of the step S320, the database management server 200 checks a past diagnosis history of the database system 100 and provides the list of diagnostic items including a recommendation for at least one diagnostic item by using the checked past diagnosis history.

In yet another embodiment of the step S320, the database management server 200 checks a current status of the database system 100 and configures a run time of the at least one script by reflecting the current status checked.

In one embodiment of the step S330, the database management server 200 provides at least one script in which the run time is specified and, if the database system's 100 load exceeds a predetermined value while the provided at least one script is running, controls the provided at least one script to stop running.

In one embodiment, the database management server 200 processes raw data generated by execution of the at least one script according to a predetermined quantitative criterion raw data generated by execution of a script received from the database system 100. For example, the database management server 200 generates a temporary table which can store the raw data, and stores in the temporary table, at least one of data obtained from execution of the script and extended data obtained from application of an extended procedure for the data. The database management server 200 determines the raw data by separating or merging at least part of the data stored in the temporary table based on information in the operating system for the database system 100.

In one embodiment, the database management server 200 obtains an evaluation result in terms of evaluation items by using processed data. For example, the database management server 200 evaluates the database system 100 by comparing the processed data with reference data assigned to the database system 100 for each of the evaluation items, and converts the comparison result into a quantitative grade data.

In one embodiment, the database management server 200 generates a diagnostic report including at least one evaluation result. For example, the database management server 200 checks a history of past diagnostic reports stored in the database system 100 and provides a result of comparing the history of past diagnostic reports with a current diagnostic report.

FIG. 4 is a flow diagram illustrating another embodiment of a method for database management according to the present invention. FIG. 4 demonstrates a method for managing database more reliably by modifying a script according to the status of the database system 100.

As shown, the database management server 200 provides a list of diagnostic items including a plurality of diagnostic items which can be carried out in the database management system 100 at S410. The database management server 200 then generates at least one script for carrying out diagnosis and relates the script to a diagnostic item at S420. Next, the database management server 200, by reflecting the status of the database system 100, modifies at least one script related to at least one diagnostic item selected from a list of diagnostic items, and carries out diagnosis by executing the modified at least one script in the database system 100 at S430.

In one embodiment, the at least one script can be configured to have a separate run time and, being executed in the database system 100 during the configured run time, can generate diagnostic data about the corresponding database system 100.

In another embodiment, the at least one script contains a predetermined query with which system information about the database system 100 can be obtained and, if a load applied to the database system 100 in response to the query exceeds a predetermined load, execution of the corresponding script is stopped. In a non-limiting embodiment, the diagnostic item includes at least one of: basic information about the database system 100, configuration management, failure management, capacity management, performance management, availability management, and security management. The at least one diagnostic item is associated with the at least one script for the corresponding diagnosis.

In one embodiment of the step S430, database management server 200 carries out a method for database management comprising checking system information of the database system 100 while the modified at least one script is running in the database system 100 and, if a load exceeding a predetermined value is applied to the database system 100, controlling the at least one script in execution to stop running.

In another embodiment of the step S430, the database management server 200 sets up a maximum run time for the at least one script by reflecting the status of the database system 100, and determines priority for each of the at least one script, wherein the priority is considered first over the maximum run time.

In one embodiment, the database management server 200 provides evaluation data calculated by comparing an execution result of the at least one script with reference data of the corresponding database system 100.

One example of a script according to the present invention is illustrated in FIGS. 5 to 12.

One embodiment of script applied to the present invention is illustrated in FIG. 5. As shown in the figure, the present invention is capable of evaluating the status of the database system 100 by using a script which is of relatively small capacity and can be carried out with little resources.

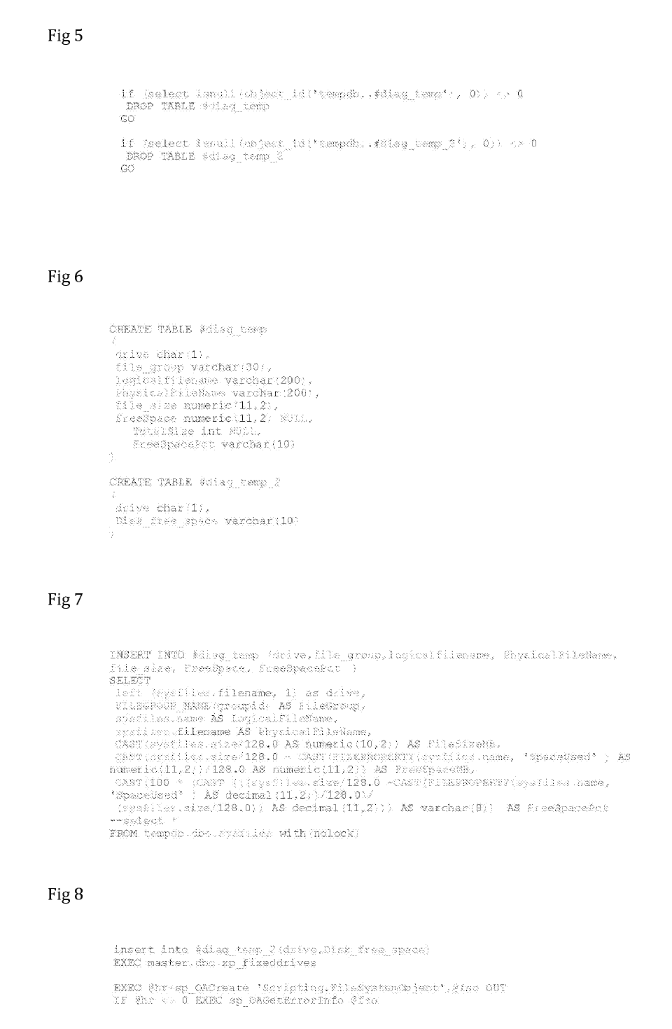

One example of a script for generating a temporary table capable of storing raw data is shown in FIG. 6, while shown in FIG. 7 is one example of a script for storing desired data into the temporary table through a catalogue view. For example, the script shown in FIG. 7 can calculate the capacity of actual physical files of various DBs distributed across a current MS SQL server.

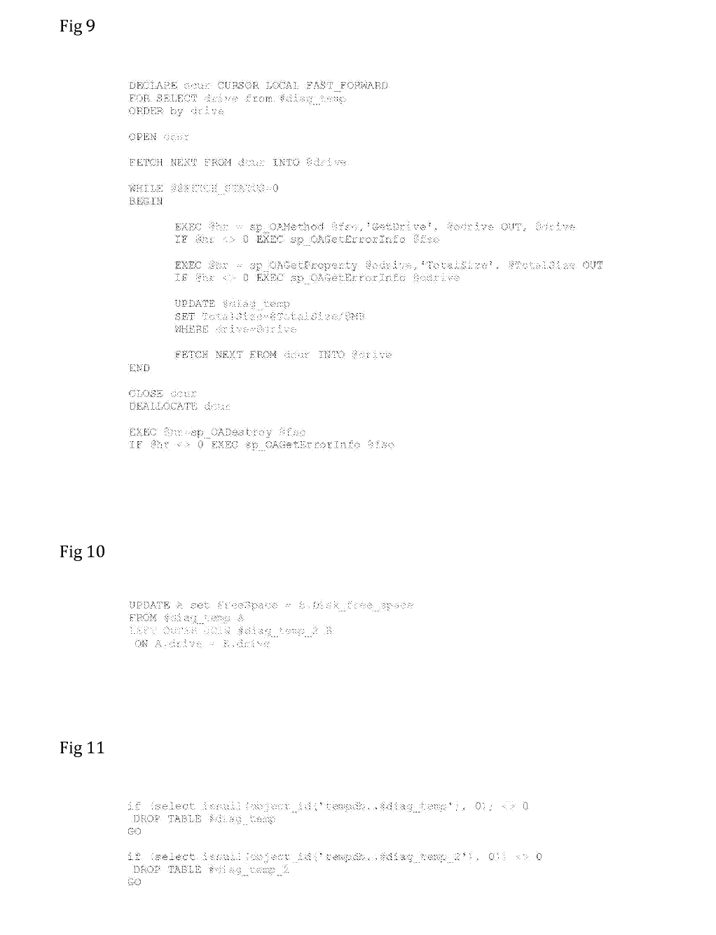

One example of a script for storing desired data into a temporary table through an extended procedure is shown in FIG. 8, while shown in FIG. 9 is one example of a predetermined script capable of retrieving information in the operating system (OS) of the database system 100. The example of FIG. 9 illustrates a script which can obtain information of the corresponding OS more easily by using APIs provided by the corresponding OS.

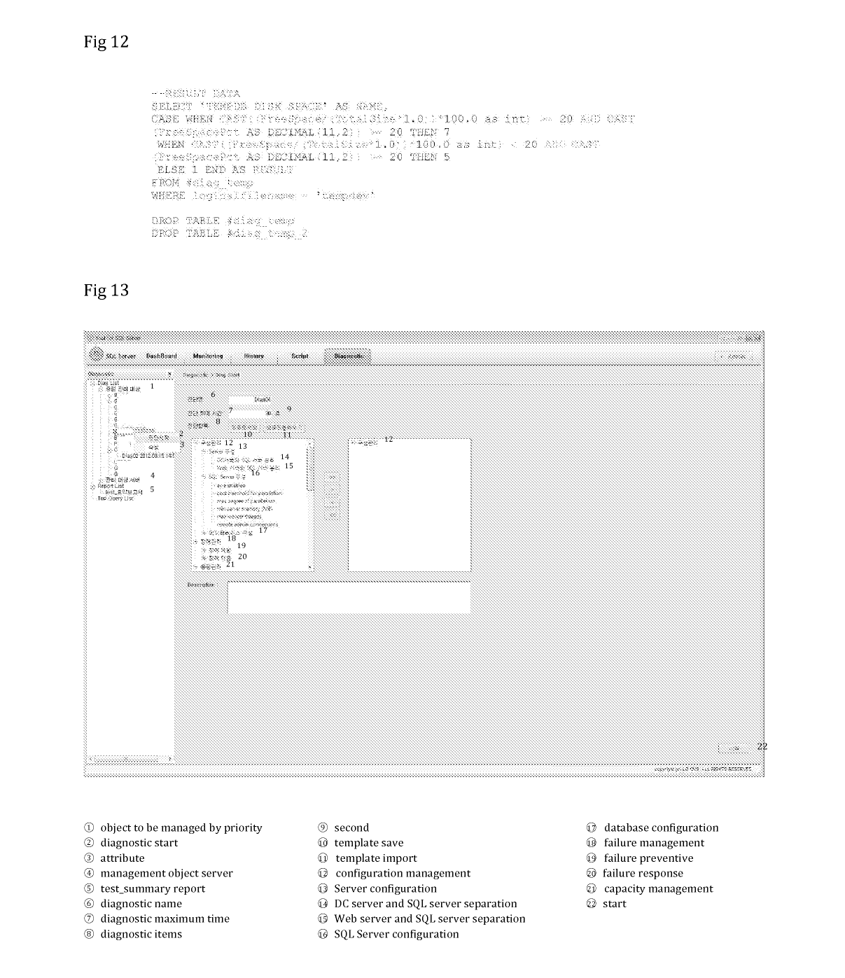

The script shown in FIG. 10 is an example for preparing raw data to be shown to the user by merging collated data according to FIGS. 7 to 8, while FIG. 11 illustrates a script for selecting first-processed raw data from the original raw data. The script of FIG. 12 illustrates operation of calculating a quantized grade by using the processed raw data.

FIGS. 13 to 18 are examples of various types of reports which can be provided to the user according to the present invention.

One example of interface for providing diagnostic items according to the present invention is shown in FIG. 13. As shown in FIG. 13, various evaluation items such as configuration management 12, failure management 18, capacity management 21, and so on are supported by the interface together with specific sub-items related thereto.

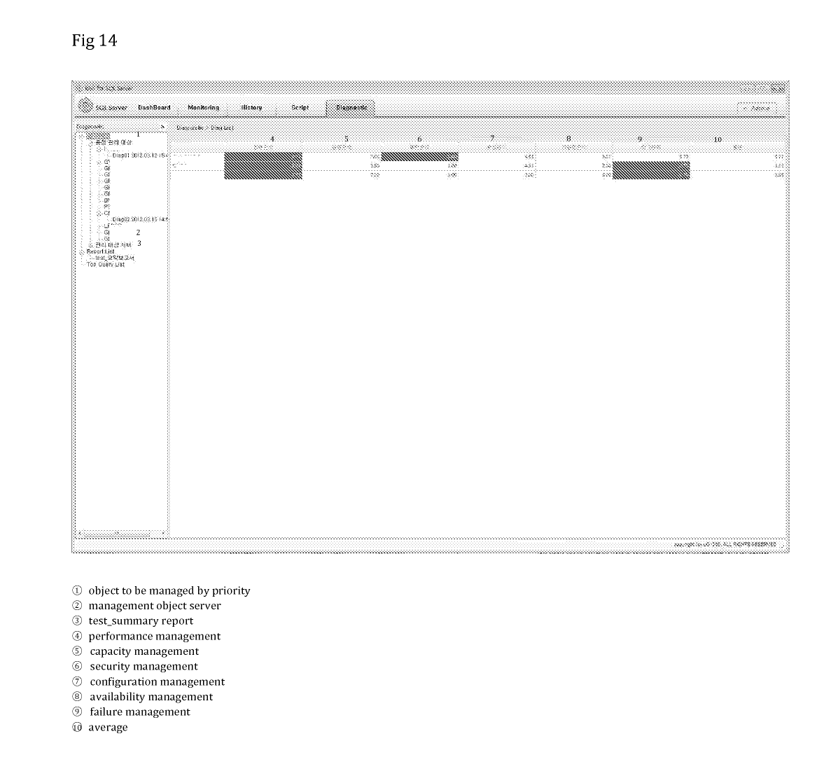

One example of an interface for an overall diagnostic board (diagnostic dashboard) about a particular database system (e.g., Diag List1) is shown in FIG. 14. As shown in the figure, it can be noticed that a diagnostic history for the particular database system is managed.

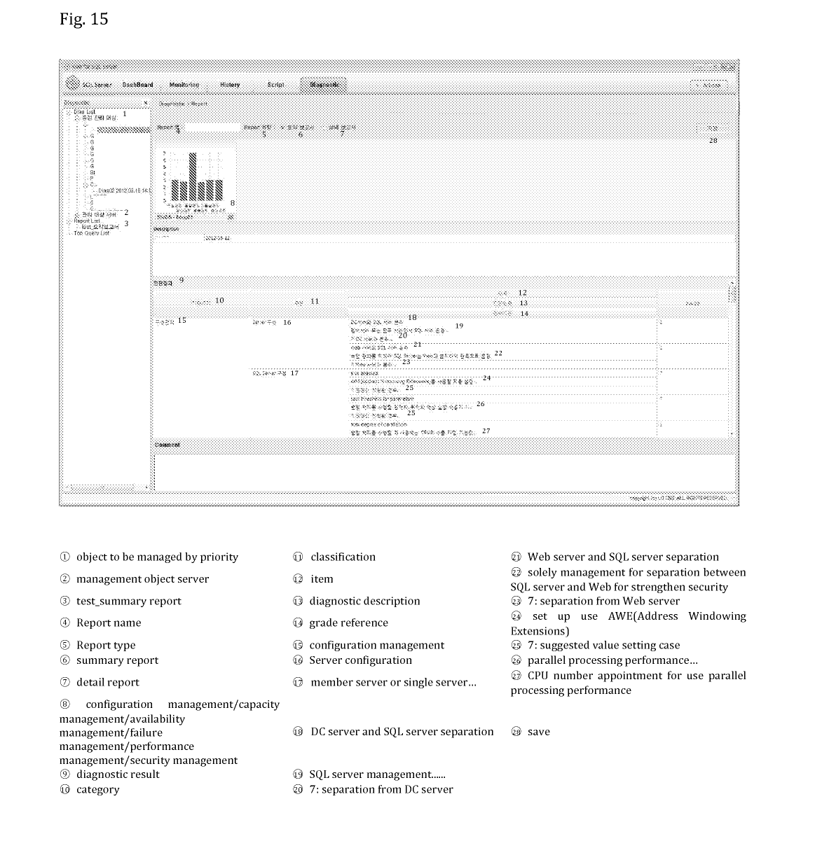

One example of a summary report 6 provided by diagnosis is shown in FIG. 15. In this non-limiting example, reports are managed by individual objects, and only one report is provided.

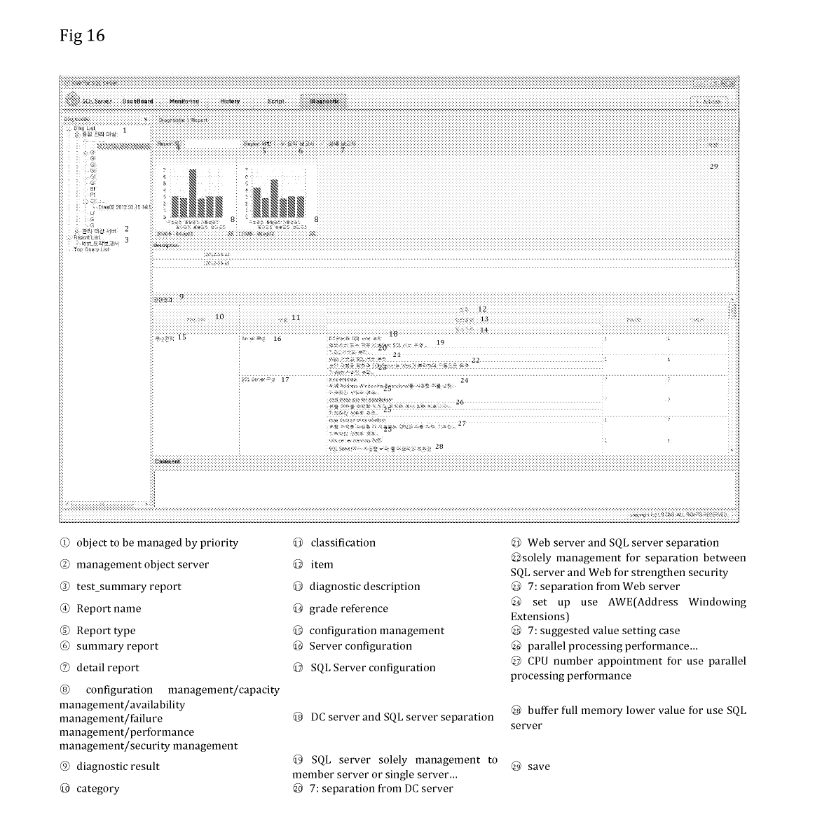

FIG. 16 illustrates a case where a plurality of diagnostic reports 8 is provided. Also, FIG. 16 shows that quantitative evaluation information about the corresponding report is, e.g., provided in a lower part of the screen. Through the information, a database manager can understand the status of the corresponding database system easily and intuitively.

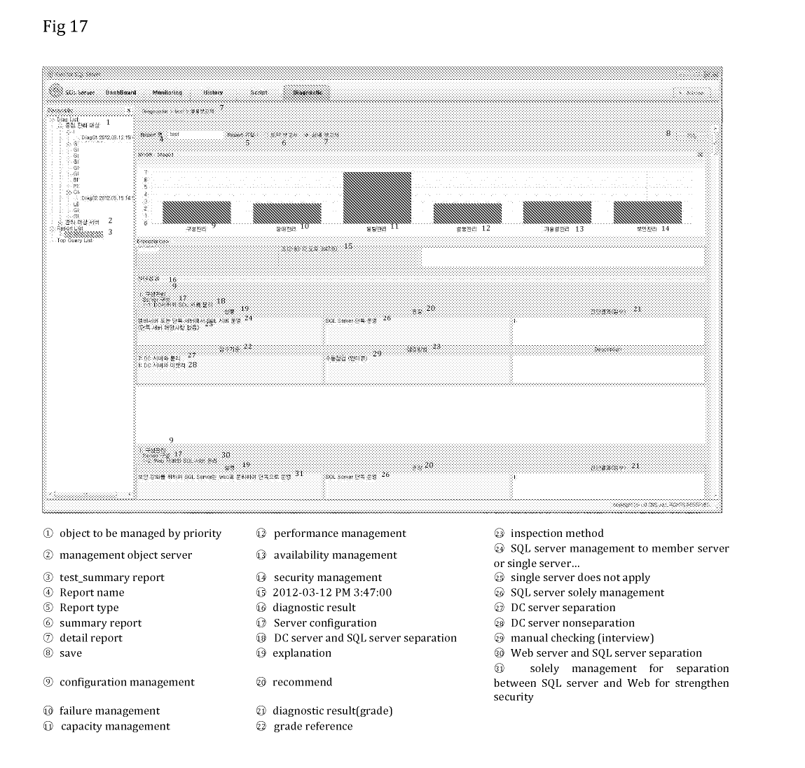

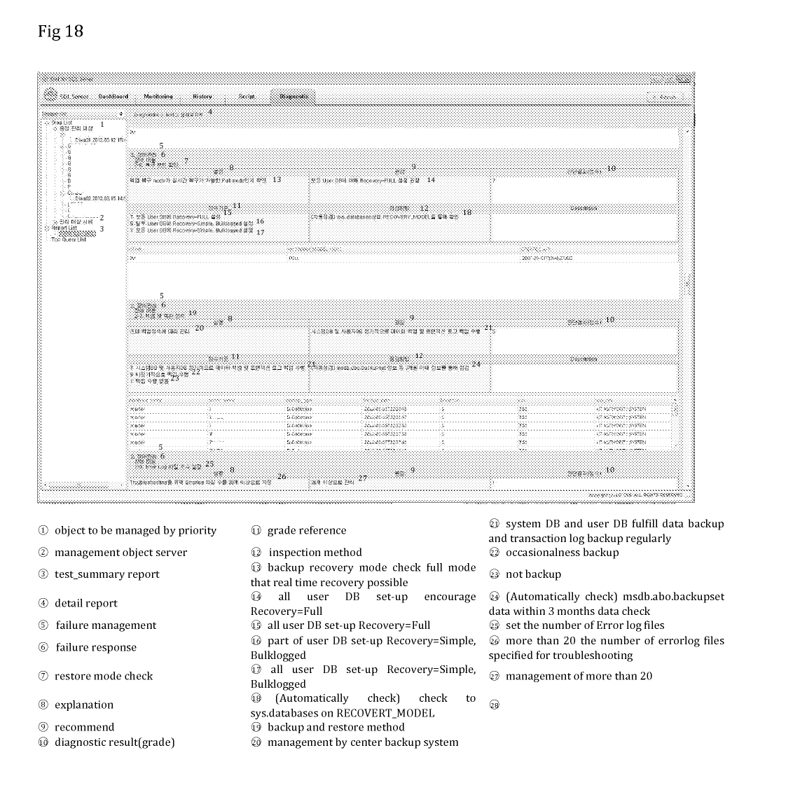

An example of a detailed report 7 screen and an example of providing raw data and information about items are shown in FIGS. 17 and 18, respectively. One can notice from FIG. 17 that the detailed report 7 screen provides a graph about diagnostic items according to individual evaluation grades, descriptions about the corresponding items, and related diagnostic results (grades). The example screen of FIG. 18 meanwhile, provides the direct contents of raw data and evaluation information about the contents.

As demonstrated, according to the present invention, an auto-generated report containing various aspects of a database system in question can be provided by providing a multi-dimensional report by processing a diagnosis result of the database system and providing a past evaluation record of the corresponding database system or a comparative evaluation report against other database systems. Since various diagnostic items are provided through remote connection to a particular database system and a quantitative analysis of the corresponding diagnosis result is provided, more complete and comfortable database management can be obtained. Accordingly, diagnosis of a remotely connected database system can be carried out more quickly and easily by using a script. Reliable performance of a database system in question can be also ensured by carrying out diagnosis with a time limit on a script and suspending the diagnosis when a load is applied to a remotely connected database system.

As described herein, the present invention provides database management, which connects to a predetermined database system through a network and is carried out in a database management server capable of providing diagnosis of the database system connected. It can be appreciated that the approaches disclosed herein can be used within a computer system, as shown in FIG. 1. In this case, one or more systems for performing the processes described in the invention can be obtained and deployed to a computer infrastructure. To this extent, the deployment can comprise one or more of: (1) installing program code on a data center device, such as a computer system, from a computer-readable storage medium; (2) adding one or more data center devices to the infrastructure; and (3) incorporating and/or modifying one or more existing systems of the infrastructure to enable the infrastructure to perform the process actions of the invention.

The exemplary database system 100 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Some of the functional units described in this specification have been labeled as modules/functions in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

For example, an implementation of exemplary database management server 200 (FIG. 2) may be stored on or transmitted across some form of computer readable media. Computer readable media can be any available media that can be accessed by a computer. By way of example, and not limitation, computer readable media may comprise “computer storage media” and “communications media.”

“Computer-readable storage device” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for database management which connects to a predetermined database system through a network and is carried out in a database management server capable of providing diagnosis of the database system, the method comprising:
generating a list of at least one database managed by the database system;
providing a list of diagnostic items including a plurality of diagnostic items which can be carried out against at least one database selected from the list; and
carrying out diagnosis by providing the database system with at least one script related to the at least one diagnostic item selected from the list of diagnostic items, wherein the at least one script is configured to have a run time set up differently according to the status of the database system.

2. The method of claim 1, wherein the carrying out diagnosis comprises:
checking a current status of the database system; and
configuring the run time of the at least one script by reflecting the current status checked.

3. The method of claim 2, wherein the carrying out diagnosis comprises:
providing at least one script in which the run time is specified; and
if the database system's load exceeds a predetermined value while the provided at least one script is running, controlling the provided at least one script to stop running.

4. The method of claim 1, wherein the providing the list of diagnostic items comprises:
generating a plurality of standardized diagnostic scripts based on a database management system (DBMS) or version information thereof; and
generating the list of diagnostic items by classifying the plurality of diagnostic scripts according to the diagnostic items.

5. The method of claim 1, wherein the providing the list of diagnostic items comprises:
checking a past diagnosis history of the database system; and
providing the list of diagnostic items including a recommendation for at least one diagnostic item by using the past diagnosis history checked.

6. The method of claim 1, further comprising processing according to a predetermined quantitative criterion raw data generated by execution of the script received from the database system.

7. The method of claim 6, wherein the processing comprises:
generating a temporary table which stores the raw data;
storing in the temporary table at least one of: data obtained from execution of the script, and extended data obtained from application of an extended procedure for the raw data; and
determining the raw data by separating or merging at least part of the raw data stored in the temporary table based on information in the operating system for the database system.

8. The method of claim 6, further comprising calculating at least one evaluation result about the at least one diagnostic item by using the processed data.

9. The method of claim 8, wherein the calculating comprises:
evaluating the database system by comparing the processed data with reference data assigned to the database system for each of the at least one evaluation item; and
converting the comparison result into a grade data.

10. The method of claim 8, further comprising generating a diagnostic report including the at least one evaluation result.

11. The method of claim 10, wherein the generating the diagnostic report comprises:
checking a history of diagnostic reports pre-generated for and stored in the database system; and
providing a comparison result after comparing the diagnostic reports pre-generated and stored with the generated diagnostic report.

12. A method for database management which is carried out in a database management server capable of connecting to a predetermined database system through a network and analyzing the connected database system, the method comprising:
providing a list of diagnostic items including a plurality of diagnostic items carried out in the database system;
generating at least one script for carrying out the diagnosis and associating the script with the diagnostic item; and
modifying the at least one script associated with the at least one diagnostic item selected from the list of diagnostic items to reflect the status of the database system and carry out diagnosis by executing the modified at least one script.

13. The method of claim 12, wherein the at least one script is configured to have a separate run time and, being executed in the database system during a configured run time, generates diagnostic data about the corresponding database system.

14. The method of claim 13, wherein the at least one script contains a predetermined query with which system information about the database system is obtained and, if a load applied to the database system in response to the query exceeds a predetermined load, execution of the corresponding script is stopped.

15. The apparatus of claim 12, wherein the diagnostic item includes at least one of: basic information about the database system, configuration management, failure management, capacity management, performance management, availability management, and security management; and
wherein the at least one diagnostic item is associated with the at least one script for the corresponding diagnosis.

16. The method of claim 12, wherein the modifying the at least one script comprises checking system information of the database system while the modified at least one script is running in the database system; and
if a load exceeding a predetermined value is applied to the database system, controlling the at least one script in execution to stop running.

17. The method of claim 12, wherein the modifying the at least one script comprises setting up a maximum run time for the at least one script by reflecting a status of the database system; and
determining priority for each of the at least one script, where the priority is considered first over the maximum run time.

18. The method of claim 12, further comprising providing evaluation data calculated by comparing an execution result of the at least one script generated from the modified at least one script with reference data of the corresponding database system.

19. A database management server, which connects to a predetermined database system through a network and provides diagnosis of the database system, the database management server comprising:
an evaluation item management unit managing a plurality of diagnostic items carried out in the database system;
a script management unit managing a plurality of scripts for carrying out a predetermined diagnosis in relation to each of the plurality of diagnostic items;
a controller selecting at least one script associated with at least one diagnostic item selected from the plurality of diagnostic items and providing the database system with the selected at least one script by setting up limiting conditions on the execution thereof.

20. The database management server of claim 19, wherein the controller sets up a maximum run time for the at least one script depending on the status of the database system, and provides the at least one script to the database system.

21. The database management server of claim 19, wherein the controller checks a load applied on the database system, which is generated by the at least one script, and if the load exceeds a predetermined threshold, controls the corresponding at least one script to stop running.

22. The database management server of claim 19, further comprising a report management unit which processes raw data generated by execution of the at least one script according to a predetermined quantitative criterion, and evaluates the database system by comparing the processed data with reference data assigned to the database system.

23. A computer-readable storage medium storing computer instructions, which when executed, enables a computer system to carry out a method for database management and provide diagnosis of a connected database system, the computer instructions comprising:
generating a list of at least one database managed by the database system;
providing a list of diagnostic items including a plurality of diagnostic items which can be carried out for at least one database selected from the list; and
carrying out a diagnosis against the database system by providing the database system with at least one script related to at least one diagnostic item selected from the list of diagnostic items, wherein the at least one script is configured to have a run time set up differently according to the status of the database system.

24. A method for deploying a database management server for use in a computer system that provides data integration using automated data processing based on target metadata, the method comprising:
providing a computer infrastructure operable to:
provide a list of diagnostic items including a plurality of diagnostic items, which can be carried out in the database system;
generate at least one script for carrying out the diagnosis and relating the generated at least one script to the diagnostic item; and
modify at least one script associated with the at least one diagnostic item selected from the list of diagnostic items by reflecting the status of the database system and carrying out diagnosis by executing the modified at least one script.
